(19) United States
(12) Patent Application Publication
(10) Pub. No.: US 2025/0238152 A1
(43) Pub. Date: Jul. 24, 2025

(54) COMPUTATIONAL STORAGE SYSTEM, OPERATING METHOD THEREOF, AND ELECTRONIC DEVICE

(71) Applicant: Samsung Electronics Co., Ltd., Suwon-si (KR)

(72) Inventors: Sangho YI, Suwon-si (KR); Kyounghweon LEE, Suwon-si (KR); Chaehwan YANG, Suwon-si (KR); Jonghun JEONG, Suwon-si (KR)

(73) Assignee: Samsung Electronics Co., Ltd., Suwon-si (KR)

(21) Appl. No.: 18/975,179

(22) Filed: Dec. 10, 2024

(30) Foreign Application Priority Data
Jan. 23, 2024 (KR) 10-2024-0010401

(51) Int. Cl. G06F 3/06

(52) U.S. Cl. CPC G06F 3/0634; G06F 3/0604; G06F 3/0679

(57) ABSTRACT

A computational storage system includes a storage device configured to store data and a computing device including a non-volatile memory express flow controller (NFC), an accelerator, and a memory, the computing device configured to perform data processing on input data provided from a host device outside the storage device or the computational storage system, the computing device, the NFC including a power management (PM) module, wherein the PM module is configured to identify whether or not a target command related to power control of the accelerator is received among a plurality of commands received from the host device and perform the power control of the accelerator based on the target command when the target command is received.

### CROSS-REFERENCE TO RELATED APPLICATION

This application is based on and claims priority under 35 U.S.C. § 119 to Korean Patent Application No. 10-2024-0010401, filed on Jan. 23, 2024, in the Korean Intellectual Property Office, the disclosure of which is incorporated by reference herein in its entirety.

### BACKGROUND

The inventive concepts relate to computational storage systems for performing power management of a computing device.

In electronic devices including storage devices and host devices, instructions (or programs) and data may be stored in the storage devices, and the instructions and the data need to be transmitted from the storage devices to the host devices to perform data processing on the basis of the instructions. Accordingly, even when processing speeds of the host devices increase, data transmission speeds between the host devices and the storage devices may act as obstacles to performance improvement and thus may limit throughput of all systems. To solve the above problem, computational storage systems including both components of existing storage devices and computing devices capable of processing data have been studied.

Recently, a non-volatile memory express (NVMe) computational storage (CS) specification has been proposed to control a storage device and a computing device of a computational storage system as one NVMe device. Here, the NVMe CS specification may be a specification added to perform data processing/computing as well as data storage in storage systems and may include the contents of commands for storing/executing programs in computational slots or accessing dynamic random access memory (DRAM) for computing. As a result, a host device may manage the storage device and the computing device through one NVMe interface (e.g., a single NVMe CS interface). However, although the storage device and the computing device are capable of being managed through one NVMe interface (e.g., the single NVMe CS interface) in the computational storage system, individual power management of the computing device may not be performed separately from the storage device. In particular, when a storage server uses a field-programmable gate array (FPGA) including the computational storage system, the computing device may consume a lot of power even in a standby state of not performing data processing/computing, and thus, power of the computing device needs to be separately managed. Therefore, there is a need for developing a method of solving the above issue.

### SUMMARY

Some example embodiments of the inventive concepts provide methods and apparatuses capable of performing individual power management of a computing device separately from power management of a storage device, in a computational storage system capable of managing the storage device and the computing device through one interface (e.g., a single non-volatile memory express (NVMe) computational storage (CS) interface).

The technical problems of the inventive concepts are not limited to the technical problems mentioned above, and other technical problems not mentioned may be clearly understood by one of ordinary skill in the art from the following descriptions.

According to an example embodiment of the inventive concepts, a computational storage system may include a storage device configured to store data and a computing device including a non-volatile memory express flow controller (NFC), an accelerator, and a memory, the computing device configured to perform data processing on input data provided from a host device outside the storage device or the computational storage system, the NFC including a power management (PM) module, wherein the PM module is configured to identify whether or not a target command related to power control of the accelerator is received among a plurality of commands received from the host device and perform the power control of the accelerator based on the target command when the target command is received.

According to an example embodiment of the inventive concepts, a method of operating a computational storage system, which includes a computing device and a storage device, may include identifying whether or not a target command related to power control of an accelerator of the computing device is received from among a plurality of commands received from a host device outside the computational storage system and performing the power control of the accelerator on the basis of the target command when receiving the target command.

According to an example embodiment of the inventive concepts, an electronic device may include a host device and a computational storage system including a storage device and a computing device, the computational storage system configured to be operatively connected to the host device, wherein the computational storage system is configured to, when receiving a first target command or a second target command related to power control of the computing device from the host device, control change of a power state of the computing device based on the first target command and the second target command and when receiving a command related to power control of the storage device from the host device, bypass the command related to the power control of the storage device to the storage device.

### BRIEF DESCRIPTION OF THE DRAWINGS

Example embodiments will be more clearly understood from the following detailed description taken in conjunction with the accompanying drawings in which:

FIGS. 1A, 1B, and 1C illustrate examples of a computational storage system according to some example embodiments;

FIG. 2 illustrates a computational storage system according to an example embodiment;

FIG. 3A illustrates an example of a field included in a signal, according to an example embodiment;

FIG. 3B illustrates an example of a field included in a signal, according to an example embodiment;

FIG. 4A is a view illustrating an operation of a computational storage system according to an example embodiment;

FIG. 4B is a view illustrating an operation of a computational storage system according to an example embodiment;

FIG. 4C is a view illustrating an operation of a computational storage system according to an example embodiment;

FIG. 5 illustrates a flowchart of a method of operating a computational storage system, according to an example embodiment;

FIG. 6 is a block diagram schematically illustrating a computational storage system and a data processing system according to an example embodiment; and

FIG. 7 is a block diagram illustrating an electronic device according to an example embodiment.

### DETAILED DESCRIPTION

Hereinafter, some example embodiments will be described in detail with reference to the accompanying drawings. The example embodiments are illustrated in the drawings and related detailed descriptions thereof are given, but the illustrations and descriptions are not intended to limit various example embodiments to particular forms. For example, it is obvious to one of ordinary skill in the art that the example embodiments may be changed in various forms.

In the description, a computational storage system may be a computational storage system that includes a storage device and a computing device and is capable of managing a storage device and a computing device through one non-volatile memory express (NVMe) interface (e.g., a single NVMe computational storage (CS) interface).

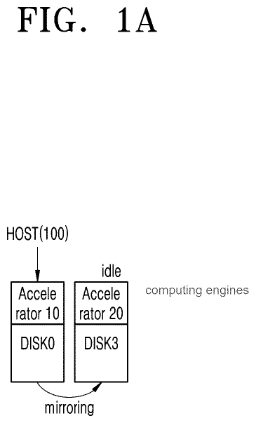

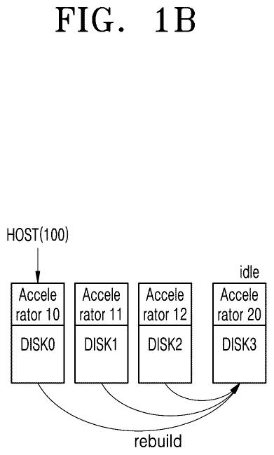

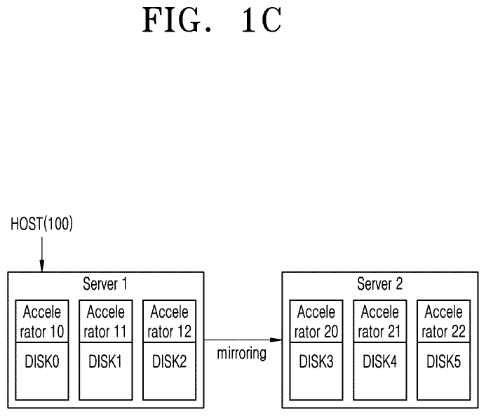

FIGS. 1A, 1B, and 1C illustrate examples of a computational storage system according to some example embodiments.

For example, FIGS. 1A, 1B, and 1C illustrate examples of cases in which computing is not performed in a computing device (e.g., an accelerator) of a computational storage system. In FIGS. 1A, 1B, and 1C, a tenth accelerator 10, an eleventh accelerator 11, a twelfth accelerator 12, a twentieth accelerator 20, a twenty first accelerator 21, and a twenty second accelerator 22 may correspond to computing engines of a plurality of computing devices included in the computational storage system.

Referring to FIG. 1A, the tenth accelerator 10 of the computational storage system may be operatively connected to a zeroth disk DISK0 and the twentieth accelerator 20 may be operatively connected to a third disk DISK3. FIG. 1A may illustrate a case in which RAID 1 is configured by using a computational storage system, but example embodiments are not limited thereto.

The computational storage system may receive a command and input data for data processing from a host 100. The computational storage system may store, in the zeroth disk DISK0, output data obtained by processing the input data according to the command on the basis of the tenth accelerator 10. The computational storage system may mirror the output data and transmit the mirrored output data to the third disk DISK3. Here, the third disk DISK3 may simply receive the output data from the zeroth disk DISK0 and store the received output data, and may not perform data computing through the twentieth accelerator 20. Therefore, the twentieth accelerator 20 may continue to consume power without performing data computing or data processing, and thus, the computational storage system needs to control a power state of the twentieth accelerator 20 to be an idle state.

Referring to FIG. 1B, a tenth accelerator 10 of a computational storage system may be operatively connected to a zeroth disk DISK0, an eleventh accelerator 11 may be operatively connected to a first disk DISK1, a twelfth accelerator 12 may be operatively connected to a second disk DISK2, and a twentieth accelerator 20 may be operatively connected to a third disk DISK3. FIG. 1B may illustrate a case in which RAID 5 is configured by using a computational storage system, but example embodiments are not limited thereto.

The computational storage system may receive a command and input data for data processing from a host 100. The computational storage system may store, in the zeroth disk DISK0, the first disk DISK1, and the second disk DISK2 connected to the tenth accelerator 10, the eleventh accelerator 11, and the twelfth accelerator 12, respectively, output data obtained by processing the input data according to the command on the basis of the tenth accelerator 10, the eleventh accelerator 11, and the twelfth accelerator 12. The computational storage system may rebuild the output data stored in the zeroth disk DISK0, the first disk DISK1, and the second disk DISK2 on the basis of the tenth accelerator 10, the eleventh accelerator 11, and the twelfth accelerator 12 and transmit the rebuilt output data to the third disk DISK3. Here, the third disk DISK3 may simply receive and store the rebuilt data and may not perform data computing through the twentieth accelerator 20. Therefore, the twentieth accelerator 20 may consume power without performing data computing or data processing, and thus, the computational storage system needs to control a power state of the twentieth accelerator 20 to be an idle state.

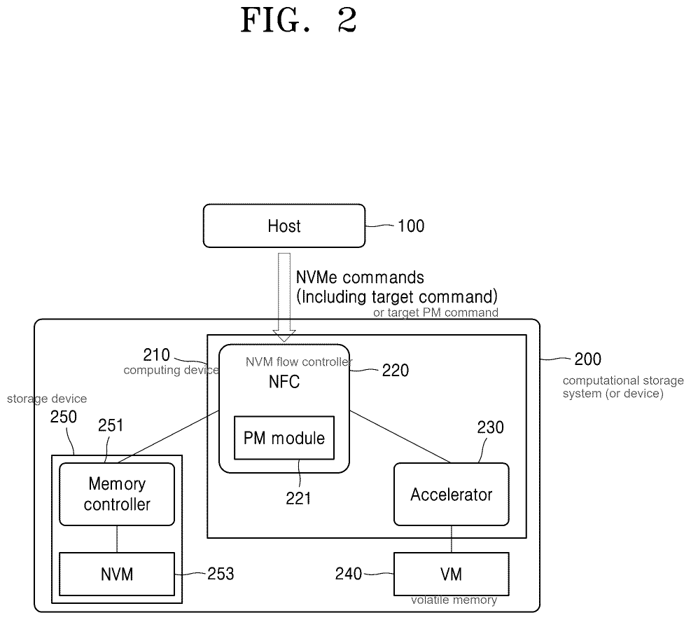

Referring to FIG. 1C, a first server 1 of a computational storage system may include a tenth accelerator 10, an eleventh accelerator 11, and a twelfth accelerator 12, and a second server 2 may include a twentieth accelerator 20, a twenty first accelerator 21, and a twenty second accelerator 22. Here, the tenth accelerator 10 may be operatively connected to a zeroth disk DISK0, the eleventh accelerator 11 may be operatively connected to a first disk DISK1, and the twelfth accelerator 12 may be operatively connected to a second disk DISK2. The twentieth accelerator 20 may be operatively connected to a third disk DISK3, the twenty first accelerator 21 may be operatively connected to a fourth disk DISK4, and the twenty second accelerator 22 may be operatively connected to a fifth disk DISK5. FIG. 1C may illustrate a case in which 2 Node high availability (HA) is configured on the basis of the first server 1 and the second server 2, but example embodiments are not limited thereto. Here, each of the first server 1 and the second server 2 may be a storage server and may be an apparatus including a host device 100 and a computational storage system 200 described below with reference to FIG. 2.

The computational storage system may receive a command and input data for data processing from a host 100. The computational storage system may store, in the zeroth disk DISK0, the first disk DISK1, and the second disk DISK2 connected to the tenth accelerator 10, the eleventh accelerator 11, and the twelfth accelerator 12, respectively, output data obtained by processing the input data according to the command on the basis of the tenth accelerator 10, the eleventh accelerator 11, and the twelfth accelerator 12. The computational storage system may mirror the output data stored in the zeroth disk DISK0, the first disk DISK1, and the second disk DISK2 and transmit the mirrored output data to the third disk DISK3, the fourth disk DISK4, and the fifth disk DISK5 of the second server 2. Here, the third disk DISK3, the fourth disk DISK4, and the fifth disk DISK5 may simply receive and store the mirrored data and may not perform data computing through the twentieth accelerator 20, the twenty first accelerator 21, and the twenty second accelerator 22. Therefore, the twentieth accelerator 20, the twenty first accelerator 21, and the twenty second accelerator 22 may consume power without performing data computing or data processing. The computational storage system needs to change power states of the twentieth accelerator 20, the twenty first accelerator 21, and the twenty second accelerator 22 to reduce or prevent undesirable power consumption.

Accordingly, some example embodiments may provide computational storage systems capable of individually controlling a power state of a computing device (e.g., an accelerator) and operating methods thereof.

For example, when a computing device (e.g., an accelerator) does not perform data computing/processing, some example embodiments may provide computational storage systems capable of reducing or preventing undesirable power consumption by changing a power state of the computing device (e.g., the accelerator) through individual power management of the computing device (e.g., the accelerator), and operating methods thereof. A detailed description thereof is given below with reference to FIGS. 2 to 5 described below.

Although some example embodiments of a computational storage system have been described on the basis of FIGS. 1A, 1B, and 1C for convenience of description, computational storage systems according to example embodiments are not limited thereto and may be various computational storage systems needing individual power management for a computing device.

According to the computational storage systems, the operating methods thereof, and the electronic devices according to some example embodiments, individual power management of a computing device may be performed.

According to the computational storage systems, the operating methods thereof, and the electronic devices according to some example embodiments, power management of the computing device may be adaptively performed according to an operation state of the computing device. For example, when the computing device does not perform a computing operation, the computational storage system may reduce or prevent undesirable power consumption in the computing device by changing a power state of the computing device.

In addition, when the power consumed by the computing device decreases, the entire energy efficiency of the computational storage system and the electronic device including the same may be improved or maximized.

FIG. 2 illustrates a computational storage system 200 according to an example embodiment.

Referring to FIG. 2, the computational storage system 200 according to an example embodiment may include a computing device 210, a volatile memory (VM) 240, and a storage device 250.

A host device 100 may manage the overall operation of the computational storage system 200. For example, the host device 100 may transmit a plurality of NVMe commands (including a target command described below) to the computational storage system 200 to manage the overall operation of the computational storage system 200.

The host device 100 may store data in the computational storage system 200 and read data from the computational storage system 200. For example, the host device 100 may store a write request and write data in the computational storage system 200 or may transmit a read request to the computational storage system 200. In addition, the host device 100 may allocate a task and data to the computational storage system 200 and control the computational storage system 200 so that the computational storage system 200 performs the task. For example, the host device 100 may transmit, to the computational storage system 200, a data processing request for performing the task together with data to be processed by the computational storage system 200, or may transmit, to the computational storage system 200, a data processing request for data pre-stored in the computational storage system 200.

In an example embodiment, the host device 100 may transmit a power management (PM) request for the computing device 210 and the storage device 250 to the computational storage system 200. For example, the host device 100 may transmit, to the computational storage system 200, a command (e.g., a target command or a target PM command) related to power management of the computing device 210. Here, the target command may include a first target command for requesting power state information supported by the computing device 210 (e.g., an adder) and a second target command for requesting current power state information of the computing device 210 (e.g., the adder) or requesting a change in a power state of the computing device 210 (e.g., the adder). Here, contents of the second target command may vary according to a value stored in a particular field (e.g., a first field). For example, when a is stored in the particular field (e.g., the first field), the second target command may be a command for requesting current power state information of the computing device 210 (e.g., the adder). As another example, when b is stored in the particular field (e.g., the first field), the second target command may be a command for requesting a change in a power state of the computing device 210 (e.g., the adder).

The host device 100 may be implemented as a central processing unit (CPU), a processor, a microprocessor, an application processor (AP), a system-on-a-chip (SoC), or the like.

The computational storage system 200 may include the computing device 210, the storage device 250, and the VM 240. The computational storage system 200 may be referred to as a computational storage device. The computational storage system 200 may store data or process data in response to a request from the host device 100. In an example embodiment, the computational storage system 200 may be implemented as a storage acceleration platform that accelerates data processing by internally storing and processing data. For example, the computational storage system 200 may be a smart solid state drive (SSD). The computational storage system 200 may be a computational storage system capable of managing the computing device 210 and the storage device 250 through one interface (e.g., a single NVMe computational storage (CS) interface).

The storage device 250 may include a memory controller 251 and a non-volatile memory (NVM) 253 and may store, in the NVM 253, data provided from the host device 100.

The memory controller 251 may manage the overall operation of the storage device 250 and may control the NVM 253 to perform an operation according to a request received from the host device 100. For example, in response to a write or read request from the host device 100, the memory controller 251 may control the NVM 253 to write data to the NVM 253 or read data from the NVM 253 and may control an erase operation of the NVM 253. In addition, the memory controller 251 may manage main operations of the NVM 253 such as garbage collection, bad block management, read reclaim, and read replacement and may manage power of the NVM 253. In an example embodiment, the memory controller 251 of the storage device 250 may change a power state of the storage device 250 on the basis of a command related to power management of the storage device 250, which is bypassed or transmitted from an NVM flow controller (NFC) 220 (or a PM module 221 of the NFC 220).

The NVM 253 may store data. The NVM 253 may store data provided from the host device 100 or data provided from the computing device 210. The NVM 253 may include a memory cell array (MCA) including non-volatile memory cells capable of maintaining stored data even when power of the storage device 250 is cut off, and the MCA may be divided into a plurality of memory blocks. The plurality of memory blocks may have a two-dimensional horizontal structure in which memory cells are two-dimensionally arranged on the same plane (or layer) or a three-dimensional vertical structure in which non-volatile memory cells are three-dimensionally arranged. A memory cell may be a single level cell (SLC) that stores one bit of data or a multi-level cell (MLC) that stores two or more bits of data. However, the inventive concepts are not limited thereto, and each memory cell may be a triple level cell (TLC) that stores 3-bit data or a quadruple level cell that stores 4-bit data.

In an example embodiment, the NVM 253 may include a plurality of dies or chips, each of which includes an MCA. For example, the NVM 253 may include a plurality of chips, and each of the plurality of chips may include a plurality of dies. In an example embodiment, the NVM 253 may also include a plurality of channels, each of which includes a plurality of chips.

In an example embodiment, the NVM 253 may be a NAND flash memory device. However, the inventive concepts are not limited thereto, and the NVM 253 may be implemented as resistive memory devices such as resistive random access memory (ReRAM), phase change RAM (PRAM), and magnetic RAM (MRAM).

The computing device 210 may be a device that performs data processing on data received and may perform data processing in response to a data processing request received from the host device 100. For example, the computing device 210 may perform data processing on input data by driving an application. The application may include a plurality of data operations related to task performing, for example, an arithmetic operation, a convolution operation, a polling operation, and/or the like. For example, when the computing device 210 performs a neural network-based task, the application may include a neural network model. The neural network model may include a plurality of data operations based on at least one of a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, or various types of neural networks, and inputs, output sizes, weights, biases, and the like of the plurality of data operations.

For example, the computing device 210 may be implemented as a graphics processing unit (GPU), a digital signal processor (DSP), a field programmable gate array (FPGA), an application specific integrated circuit (ASIC), a neural processing unit (NPU), or the like. However, the computing device 210 is not limited thereto and may include various types of accelerators (or accelerator circuits) 230 that in parallel perform data processing needed for performing an allocated task, for example, data computing.

The computing device 210 may include the NFC 220 including the PM module 221, and the accelerator 230.

The NFC 220 may manage, within the computational storage system 200, transmission of a request, data, and the like between the host device 100 and the accelerator 230 inside the computing device 210. In addition, the NFC 220 may manage, within the computational storage system 200, transmission of a request, data, and the like between the host device 100 and the storage device 210. For example, the NFC 220 may support an NVMe CS specification (e.g., a single NVMe CS interface specification or the like), but example embodiments are not limited thereto.

The NFC 220 may receive a plurality of commands for the storage device 250 and the computing device 210 (e.g., the accelerator 230). For example, the NFC 220 may receive a data processing request from the host device 100. The data processing request may be a request for the computing device 210 to perform data processing on data pre-stored in the storage device 250 or data processing on data received from the host device 100. When receiving the data processing request from the host device 100, the NFC 220 may transmit the data processing request to the accelerator 230. Accordingly, data processing corresponding to the data processing request may be performed through the accelerator 230 of the computing device 210.

The NFC 220 (or the PM module 221) according to an example embodiment may bypass or transmit a command related to power management of the storage device 250 to the storage device 250, in response to receiving the command related to the power management of the storage device 250 from among the plurality of commands.

In an example embodiment, the NFC 220 may include the PM module 221. The PM module 221 of the NFC 220 may be a module for controlling a power state of the accelerator 230. The PM module 221 may identify (or parse) commands (e.g., a first target command and/or a second target command) related to power management of the computing device 210 (e.g., the accelerator 230), from among the plurality of commands. The commands related to the power management of the computing device 210 (e.g., the accelerator 230) may be referred to as target commands (e.g., target PM commands).

In an example embodiment, in response to receiving the first target command from the host device 100, the PM module 221 of the NFC 220 may store, in a zeroth field of the first target command, information regarding whether or not the computational storage system 200 supports the NVMe CS specification (e.g., the single NVMe CS interface specification or the like), store, in a first field of the first target command, information regarding the number of power states supported by the accelerator 230, and store, in a second field of the first target command, information regarding characteristics of the power states supported by the accelerator 230. The PM module 221 may transmit, to the host device 100, the first target command storing the pieces of above-described information in the zeroth filed, the first field, and the second field, respectively.

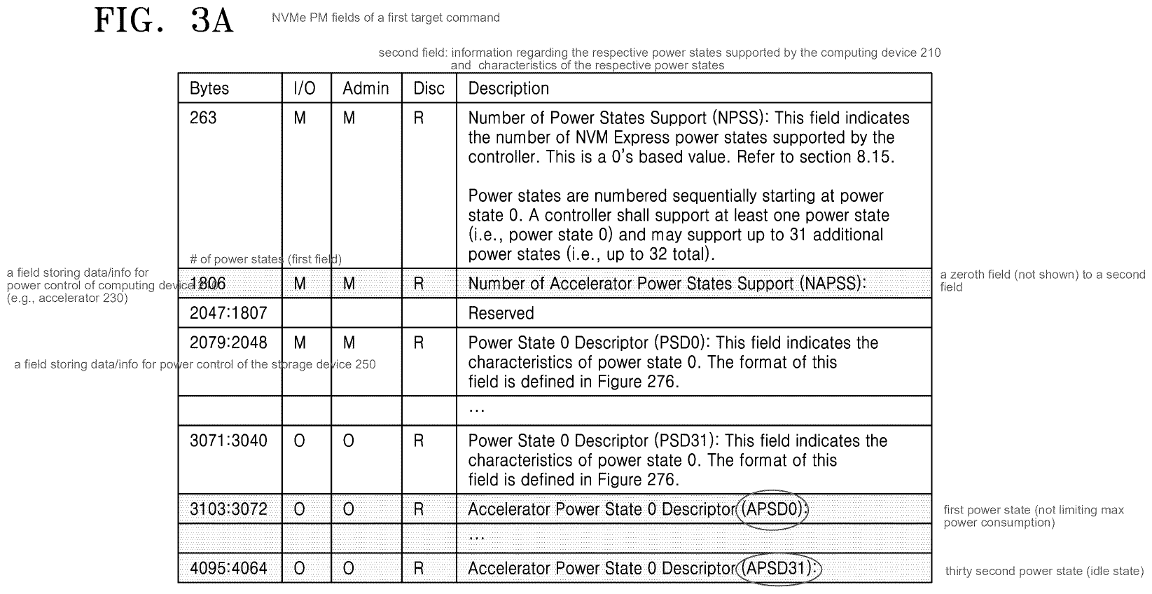

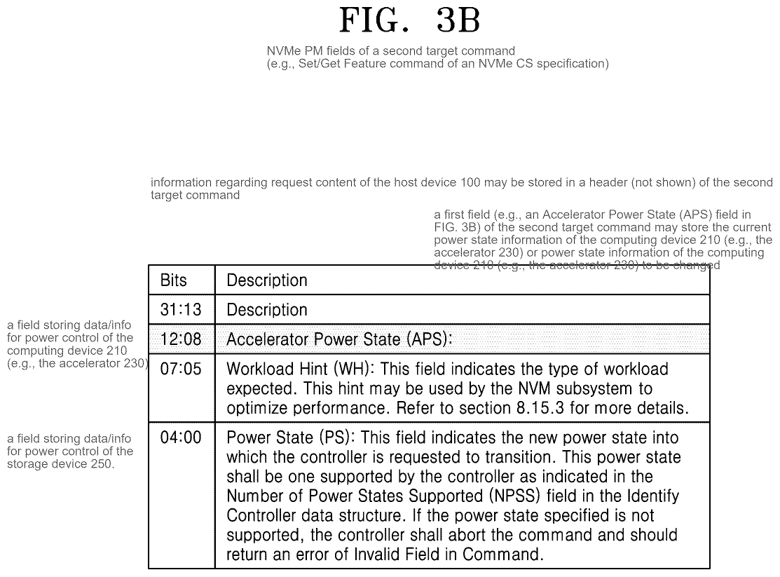

In an example embodiment, the host device 100 may store a request for the NFC 220 (e.g., a request for current power state information of the accelerator 230) in a particular field (e.g., a first field) of the second target command and transmit the stored request to the NFC 220. The PM module 221 of the NFC 220 of the computing device 210 may decode the second target command received from the host device 100. As a result of the decoding, when the second target command is a command for requesting the current power state information of the accelerator 230, the PM module 221 may transmit a signal for requesting the current power state information of the accelerator 230 to the accelerator 230 on the basis of the second target command. The PM module 221 may receive the current power state information of the accelerator 230 from the accelerator 230. The PM module 221 may store the current power state information of the accelerator 230 in a particular field (e.g., a second field) of the second target command and transmit the stored current power state information to the host device 100. A detailed description of the second target command is given below with reference to FIG. 3B.

In an example embodiment, the host device 100 may store a request for the NFC 220 (e.g., a request for changing a power state of the accelerator 230) in the particular field (e.g., the first field) of the second target command, store power state information of the accelerator 230 to be changed, in the particular field (e.g., the second field) of the second target command, and transmit the second target command, the stored request, and the stored power state information to the NFC 220. The PM module 221 of the NFC 220 of the computing device 210 may decode the second target command received from the host device 100. As a result of the decoding, when the second target command is a command for requesting a change in the power state of the accelerator 230, the PM module 221 may transmit a control signal for changing the power state of the accelerator 230 to the accelerator 230 on the basis of the second target command. The accelerator 230 may change a power state thereof to the power state included in the control signal (e.g., the power state requested by the host device 100 through the second field of the second target command). A detailed description of the second target command is given with reference to FIG. 3B.

The accelerator 230 may perform data processing in response to the data processing request. The accelerator 230 may perform data processing on data pre-stored in the storage device 250 or perform data processing on data received from the host device 100, in response to the data processing request. The accelerator 230 may store, in an internal register, a value calculated in a data processing process. In addition, the accelerator 230 may store, in the VM 240, data generated in a data processing process and data generated as a result of the data processing. The accelerator 230 may store the data generated as the result of the data processing in the storage device 250 through the NFC 220.

In an example embodiment, the accelerator 230 may transmit the power state information (e.g., the information regarding the number of power states supported by the accelerator 230, and the information regarding the characteristics of the power states) supported by the accelerator 230 to the NFC 220, in response to receiving the control signal corresponding to the first target command from the NFC 220.

In an example embodiment, the accelerator 230 may transmit the current power state information of the accelerator 230 to the NFC 220, in response to receiving the control signal corresponding to the second target command from the NFC 220.

In an example embodiment, the accelerator 230 may change the power state of the accelerator 230 according to the control signal, in response to receiving the control signal corresponding to the second target command from the NFC 220. For example, the accelerator 230 may change the power state of the accelerator 230 to a power state included in the control signal (e.g., a power state requested by the host device 100).

The VM 240 may store data used for the data processing by the computing device 210. The VM 240 may store the data generated by the computing device 210 or the data generated as the result of the data processing. Here, when the computing device 210 performs the data processing on the basis of the data stored in the storage device 250, the data stored in the storage device 250 may be read and stored in the VM 240. The VM 240 may be implemented as a volatile memory such as DRAM, static RAM (SRAM), or the like.

As described above, when using the computational storage system 200 according to an example embodiment, power control of the computing device 210 (e.g., the accelerator 230 of the computing device 210) may be performed separately from the storage device 250, and thus, undesirable power consumption may be reduced or prevented in the computing device 210 to improve energy efficiency of the entire computational storage system 200.

FIG. 3A illustrates an example of a field included in a signal according to an example embodiment.

For example, FIG. 3A illustrates fields (hereinafter, referred to as NVMe PM fields) for power management of the computing device 210 (e.g., the accelerator 230) of the computational storage system 200, which are included in a first target command according to an example embodiment. For example, the first target command may correspond to a command of an NVMe CS specification (e.g., an identify controller command). However, example embodiments are not limited thereto.

Referring to FIG. 3A, the NVMe PM fields (the table of FIG. 3A) of the first target command according to an example embodiment may include a field (e.g., a hatched portion of the table of FIG. 3A) storing data/information for power control of the computing device 210 (e.g., the accelerator 230) and a field (e.g., an unhatched portion of the table of FIG. 3A) storing data/information for power control of the storage device 250.

In an example embodiment, in the first target command, the field (e.g., the hatched portion of FIG. 3A) storing the data/information for the power control of the computing device 210 (e.g., the accelerator 230) may include a zeroth field (not shown) to a second field.

In an example embodiment, information regarding an interface supported by the computational storage system 200 (e.g., information regarding an interface-related NVMe CS specification) may be stored (e.g., OACS[13]=1) in the zeroth field (not shown) (e.g., an Optional Admin Common Support (OACS) Bits field) of the first target command. For example, the host device 100 may identify whether or not the computational storage system 200 supports the NVMe CS specification (e.g., a single NVMe CS interface specification or the like) by decoding the zeroth field (not shown) of the first target command received from the NFC 220. For example, when OACS[13]=1, the host device 100 may identify that the computational storage system 200 supports the NVMe CS specification.

In an example embodiment, information (e.g., 1,806 bytes) regarding the number of power states supported by the computing device 210 (e.g., the accelerator 230) may be stored in the first field (e.g., a Number of Accelerator Power States Support (NAPSS) field of FIG. 3A) of the first target command. For example, the host device 100 may identify the number (e.g., 32) of power states supported by the computing device 210 (e.g., the accelerator 230) by identifying data of the first field (e.g., the NAPSS field of FIG. 3A) of the first target command received from the NFC 220.

In an example embodiment, information (e.g., descriptors of the respective power states) regarding the respective power states supported by the computing device 210 (e.g., the accelerator 230) and characteristics of the respective power states may be stored in a second field of the first target command. The second field may include a plurality of subfields (e.g., a first Accelerator Power State Descriptor field APSD0 to a thirty second APSD field APSD31 of FIG. 3A) corresponding to the power states supported by the computing device 210 (e.g., the accelerator 230), respectively.

For example, the host device 100 may identify the respective power states supported by the computing device 210 (e.g., the accelerator 230) and the characteristics of the respective power states by identifying data of the subfields (e.g., the first APSD field APSD0 to the thirty second APSD field APSD31 of FIG. 3A) of the second field of the first target command received from the NFC 220. Here, the first APSD field APSD0 (e.g., Bytes 3103:3072) may include information regarding characteristics of a first power state of the computing device 210 (e.g., the accelerator 230), and the thirty second APSD field APSD31 (e.g., Bytes 4095:4064) may include information regarding characteristics of a thirty second power state of the computing device 210 (e.g., the accelerator 230). For example, the first power state of the computing device 210 (e.g., the accelerator 230) may refer to a state of not limiting maximum power consumption of the computing device 210 (e.g., the accelerator 230), a second power state of the computing device 210 (e.g., the accelerator 230) may refer to a state of limiting 10% of the maximum power consumption of the computing device 210 (e.g., the accelerator 230), a third power state of the computing device 210 (e.g., the accelerator 230) may refer to a state of limiting 20% of the maximum power consumption of the computing device 210 (e.g., the accelerator 230), and a thirty second power state of the computing device 210 (e.g., the accelerator 230) may refer to an idle state of maximally limiting the maximum power consumption of the computing device 210 (e.g., the accelerator 230). (However, the power states supported by the computing device 210 (e.g., the accelerator 230) according to this example embodiment are examples for convenience of description. Example embodiments are not limited thereto, and may include various different power states.

As described above, the PM module 221 of the NFC 220 may provide the host device 100 with power states that may be supported by the computing device 210 (e.g., the accelerator 230) through the subfields (e.g., the first APSD field APSD0 to the thirty second field APSD31) of the second field of the first target command so that the host device 100 may change/set the power state of the computing device 210 (e.g., the accelerator 230).

Although FIG. 3A illustrates that the number of power states supported by the computing device 210 (e.g., the accelerator 230) is 32 for convenience of description, the power states supported by the computing device 210 (e.g., the accelerator 230) according to example embodiments are not limited thereto and may include fewer or more power states.

FIG. 3B illustrates an example of a field included in a signal according to an example embodiment.

For example, FIG. 3B illustrates fields (hereinafter, referred to as NVMe PM fields) for power management of the computing device 210 (e.g., the accelerator 230) of the computational storage system 200, which are included in a second target command according to an example embodiment. For example, the second target command may correspond to a Set/Get Feature command of an NVMe CS specification. However, second target commands according to example embodiments are not limited thereto.

Referring to FIG. 3B, the NVMe PM fields (the table of FIG. 3B) of the second target command according to an example embodiment may include a field (e.g., a hatched portion in the table of FIG. 3B) storing data/information for power control of the computing device 210 (e.g., the accelerator 230) and a field (e.g., an unhatched portion in the table of FIG. 3B) storing data/information for power control of the storage device 250.

In an example embodiment, in the second target command, the field (e.g., the hatched portion of FIG. 3B) storing the data/information for the power control of the computing device 210 (e.g., the accelerator 230) may include a first field.

In an example embodiment, information regarding request content of the host device 100 may be stored in a header (not shown) of the second target command. The NFC 220 may identify the request content of the host device 100 by decoding the header of the second target command. For example, the PM module 221 of the NFC 220 may decode the header of the second target command to identify whether the host device 100 requests current power state information of the computing device 210 (e.g., the accelerator 230) or requests a change in a power state of the computing device 210 (e.g., the accelerator 230).

In an example embodiment, a first field (e.g., an Accelerator Power State (APS) field in FIG. 3B) of the second target command may store the current power state information of the computing device 210 (e.g., the accelerator 230) or power state information of the computing device 210 (e.g., the accelerator 230) to be changed.

In an example embodiment, as a result of decoding the header of the second target command, when the host device 100 requests the current power state information of the computing device 210 (e.g., the accelerator 230), the PM module 221 of the NFC 220 may store the current power state information of the computing device 210 (e.g., the accelerator 230) in the first field (e.g., the APS field of FIG. 3B) of the second target command and transmit the stored current power state information to the host device 100.

In an example embodiment, as the result of decoding the header of the second target command, when the host device 100 requests the change in the power state of the computing device 210 (e.g., the accelerator 230), the host device 100 may store the information regarding the power state of the computing device 210 (e.g., the accelerator 230) to be changed in the first field (e.g., the APS field of FIG. 3B) of the second target command and transmit the stored information to the NFC 220. For example, the host device 100 may store any one of power states (e.g., the first power state to the thirty second power states of FIG. 3A) supported by the computing device 210 (e.g., the accelerator 230) as a power state of the computing device 210 (e.g., the accelerator 230) to be changed in the first field (e.g., the APS field of FIG. 3B) of the second target command and transmit the stored power state to the NFC 220. The PM module 221 may transmit, to the accelerator 230, a control signal for changing the power state of the accelerator 230. The accelerator 230 may change the power state of the accelerator 230 to a power state included in the control signal. When information regarding a power state, which is not supported by the accelerator 230, is stored in the first field of the second target command, the PM module 221 of the NFC 220 may stop an operation according to the second command and return a field error to the host device 100. The second target command for changing the power state of the computing device 210 (e.g., the accelerator 230) may be transmitted from the host device 100 to the NFC 220 when an operation state of the computing device 210 is changed (e.g., changed from an idle state to an active state or the like).

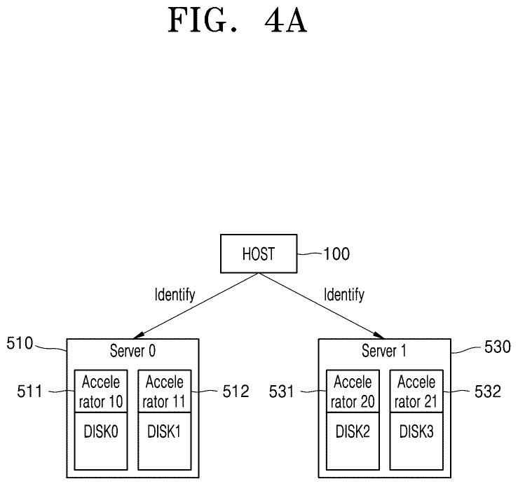

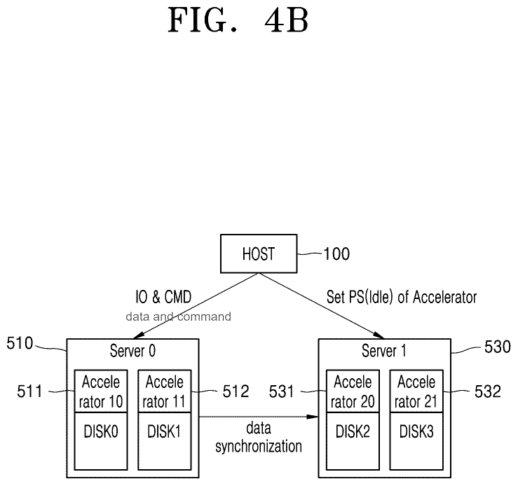

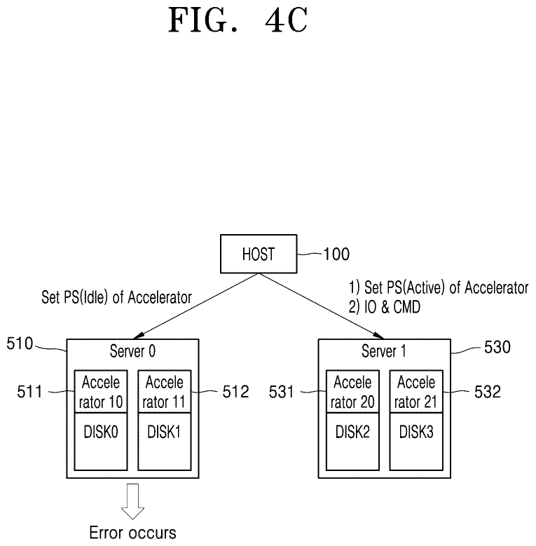

FIG. 4A is a view illustrating an operation of a computational storage system according to an example embodiment.

FIGS. 4A to 4C are diagrams illustrating an operation in which the NFC 220 (e.g., the PM module 221) of the computational storage system 200 controls power of the computing device 210 (e.g., the accelerator 230) when 2 Node HA is configured by using storage servers (e.g., a zeroth server Server 0 510 and a first server Server 1 530. In FIGS. 4A to 4C, each of the storage servers (e.g., the zeroth server Server 0 510 and the first server Server 1 530) may include the computational storage system 200 including the computing device 210 and a host device 100. The same descriptions of FIGS. 4A to 4C as the descriptions of FIGS. 1 to 3B are replaced with the above descriptions of FIGS. 1 to 3B.

Referring to FIG. 4A, the host device 100 may transmit a first target command to the storage servers (e.g., the zeroth server Server 0 510 and the first server Server 1 530) to identify interface information (e.g., information regarding an interface-related NVMe CS specification) supported by the storage servers (e.g., the zeroth server Server 0 510 and the first server Server 1 530) (or the computational storage system 200 included in each of the storage servers). The NFC 220 (e.g., the PM module 221) included in each of the storage servers (e.g., the zeroth server Server 0 510 and the first server Server 1 530) may store, in the first target command (refer to FIG. 3A), 1) information regarding an interface supported by each computational storage system 200 (e.g., information regarding an interface-related NVMe CS specification) and 2) information regarding power states supported by accelerators (e.g., a tenth accelerator 10 511 to a twenty first accelerator 21 532) of each computational storage system 200 (e.g., information regarding the number/characteristics of power states supported) and transmit the stored information to the host device 100. The host device 100 may identify/verify, through the first target command received from the NFC 220, whether or not each of the storage servers (e.g., the zeroth server Server 0 510 and the first server Server 1 530) (or the computational storage system 200 included in each of the storage servers) support the NVMe CS specification, and power states supported by the accelerators (e.g. the tenth accelerator 10 511 to the twenty first accelerator 21 532) of the computational storage system 200 of each of the storage servers (e.g., the zeroth server Server 0 510 and the first server Server 1 530).

FIG. 4B is a diagram illustrating an operation of a computational storage system according to an example embodiment.

Referring to FIG. 4B, a host device 100 may transmit data IO and a command CMD (e.g., a command for instructing computing and data synchronization (for configuring 2 Node HA) to a zeroth server Server 0 510. The zeroth server Server 0 510 may store, in a zeroth disk DISK0 and a first disk DISK1, output data obtained by performing computing on the data IO according to the command CMD on the basis of a tenth accelerator 10 511 and an eleventh accelerator 11 512. The zeroth server Server 0 510 may synchronize the output data with the first server Server 1 530 to configure the 2 Node HA according to the command CMD (synchronize data). For example, the zeroth server Server 0 510 may transmit the output data stored in the zeroth disk DISK0 and the first disk DISK1 to a second disk DISK2 and a third disk DISK3 of the first server Server 1 530. Here, the second disk DISK2 and the third disk DISK3 receive the output data from the zeroth disk DISK0 and the first disk DISK1 and store the received output data, simply for data synchronization and may not perform data computing through a twentieth accelerator 20 531 and a twenty first accelerator 21 532. Accordingly, the host device 100 may change/set power states of the twentieth accelerator 20 531 and the twenty first accelerator 21 532 to an idle state. For example, the host device 100 may transmit, to the NFC 220 of the first server 1 530, a second target command for requesting a change in the power states of the twentieth accelerator 20 531 and the twenty first accelerator 21 532 (refer to FIG. 3B). In response to receiving the second target command, the NFC 220 (e.g., the PM module 221) of the first server Server 1 530 may transmit, to the twentieth accelerator 20 531 and the twenty first accelerator 21 532, a control signal for changing the power states of the twentieth accelerator 20 531 and the twenty first accelerator 21 532 according to the second target command. The twentieth accelerator 20 531 and the twenty first accelerator 21 532 may change the power states thereof to the idle state according to the received control signal.

FIG. 4C is a diagram illustrating an operation of a computational storage system according to an example embodiment.

Referring to FIG. 4C, after configuring the 2 Node HA of FIG. 4B, an error may occur in a zeroth server Server 0 510, and the zeroth server Server 0 510 may failover to a first server Server 1 530. A host device 100 may set, to an idle state PS (Idle), power states of a tenth accelerator 10 511 and an eleventh accelerator 11 512 of the zeroth server Server 0 510 in which the error occurs. For example, the host device 100 may transmit, to the NFC 220 of the zeroth server Server 0 510, a second target command for requesting a change in the power states of the tenth accelerator 10 511 and the eleventh accelerator 11 512. In response to receiving the second target command, the NFC 220 (e.g., the PM module 221) of the zeroth server Server 0 510 may transmit, to the tenth accelerator 10 511 and the eleventh accelerator 11 512, a control signal for changing the power states of the tenth accelerator 10 511 and the eleventh accelerator 11 512 according to the second target command. The tenth accelerator 10 511 and the eleventh accelerator 11 512 may change the power states thereof to the idle state PS (Idle) according to the received control signal.

The host device 100 may continue to perform a service through the first server Server 1 530 on behalf of the zeroth server Server 0 510 in which the error occurs. The host device 100 may change/set power states of a twentieth accelerator 20 531 and a twenty first accelerator 21 532 of the first server Server 1 530 to an active state PS (Active) to continue performing the service (e.g., data computing) through the first server Server 1 530. For example, the host device 100 may transmit, to the NFC 220 of the first server Server 1 530, a second target command for requesting a change in the power states of the twentieth accelerator 20 531 and the twenty first accelerator 21 532 (refer to FIG. 3B). In response to receiving the second target command, the NFC 220 (e.g., the PM module 221) of the first server Server 1 530 may transmit, to the twentieth accelerator 20 531 and the twenty first accelerator 21 532, a control signal for changing the power states of the twentieth accelerator 20 531 and the twenty first accelerator 21 532 according to the second target command. The twentieth accelerator 20 531 and the twenty first accelerator 21 532 may change the power states thereof from the idle state PS (Idle) to the active state PS (Active) according to the received control signal.

The host device 100 may transmit data IO and a command CMD (e.g., a command for instructing to perform computing according to failover) to the first server 1 530. The first server Server 1 530 may store, in a second disk DISK2 and a third disk DISK3, output data obtained by performing computing on the data IO according to the command CMD on the basis of the twentieth accelerator 20 531 and the twenty first accelerators 21 532, which are activated.

As described above with reference to FIGS. 4A to 4C, an apparatuses and methods according to those example embodiment may improve energy efficiency of the entire system by adaptively performing power control of the computing device 210 (e.g., the accelerator 230) according to an operation state of the computing device 210 (e.g., the accelerator 230 (e.g., separately from the storage device 250)).

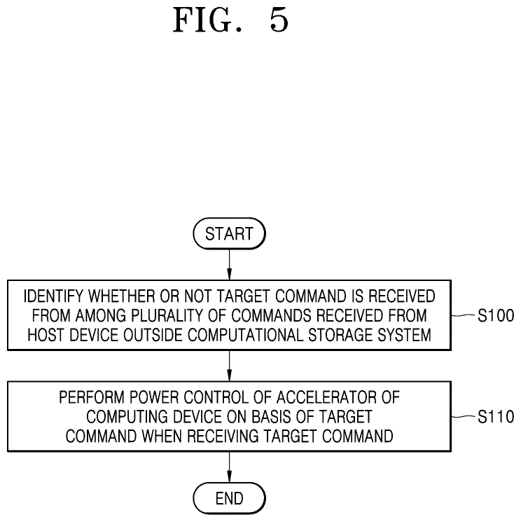

FIG. 5 illustrates a flowchart of a method of operating a computational storage system, according to an example embodiment.

Referring to FIG. 5, the operating method for power control of the computing device 210 (e.g., the accelerator 230) by the NFC 220 (e.g., the PM module 221) of the computational storage system 200 may include operations S100 and S110. The same description of FIG. 5 as descriptions of FIGS. 1 to 4C is replaced with the descriptions of FIGS. 1 to 4C. The computational storage system 200, the computing device 210, the NFC 220, the PM module 221, the accelerator 230, and the storage device 250 described with reference to FIG. 5 may correspond to the computational storage system 200, the computing device 210, the NFC 220, the PM module 221, the accelerator 230, and the storage device 250 of FIGS. 1 to 4C, respectively.

In the description, a computational storage system may be a computational storage system that includes a storage device and a computing device and is capable of managing the storage device and the computing device through one NVMe interface (e.g., a single NVMe CS interface).

In operation S100, the PM module 221 of the NFC 220 may identify whether or not a target command is received from among a plurality of commands received from the host device 100 outside the computational storage system. Here, the target command may refer to at least one command related to power control of the accelerator 230, from among the plurality of commands. For example, the type of target command may include a first target command for requesting power state information supported by the accelerator 230 and a second target command for requesting current power state information of the accelerator 230 or changing a power state of the accelerator 230.

In an example embodiment, the PM module 221 may bypass or transmit a command related to power control of the storage device 250 to the storage device 250, in response to receiving the command related to the power control of the storage device 250 from among the plurality of commands received from the host device 100.

In operation S110, when receiving the target command, the PM module 221 of the NFC 220 may perform the power control of the accelerator 230 of the computing device 210 on the basis of the target command.

In an example embodiment, in response to receiving the first target command from the host device 100, the PM module 221 may store, in a first field of the first target command, information regarding the number of power states supported by the accelerator 230, store, in subfields of a second field of the first target command, information regarding characteristics of each of the power states supported by the accelerator 230, and transmit, to the host device 100, the first target command storing the information in the first field and the second field.

In an example embodiment, when receiving the second target command, the PM module 221 may identify request content of the host device 100 by decoding a header of the second target command.

In an example embodiment, when the request content of the host device requests current power state information of the accelerator 230, the PM module 221 may transmit, to the accelerator 230, a signal for requesting the current power state information of the accelerator 230 on the basis of the second target command. The PM module 221 may receive the current power state information of the accelerator 230 from the accelerator 230. The PM module 221 may store the current power state information of the accelerator 230 in a first field of the second target command and transmit the stored current power state information to the host device 100.

In an example embodiment, when the request content of the host device 210 requests a change in the power state of the accelerator 230, the PM module 221 may transmit, to the accelerator 230, a control signal for changing the power state of the accelerator 230 on the basis of the second target command. In the first field of the second target command, information regarding the power state of the accelerator 230 to be changed may be stored by the host device 100. The second target command for changing the power state of the accelerator 230 may be transmitted from the host device 100 to the NFC 220 when an operation state of the computing device 210 (e.g., the accelerator 230) is changed (e.g., changed from an idle state to an active state). For example, unlike in a previous state, when computing is not performed by the computing device 210 (e.g., the accelerator 230), the second target command for changing the power state of the accelerator 230 may be transmitted from the host device 100 to the NFC 220 of the computational storage system 200. For example, a case in which computing is not performed by the computing device 210 (e.g., the accelerator 230) may include a case in which a memory included in the computing device 210 stores mirrored data (e.g., configures RAID1), a case in which the memory included in the computing device 210 stores rebuilt data (e.g., configures RAID5), and a case in which a storage server to which the computing device 210 belongs stores mirrored data (e.g., storage server-based 2 Node HA configuration) (refer to FIG. 4B). For example, unlike in the previous state, when an error occurs in another storage server and thus the storage server fails over to a server to which the computing device 210 belongs (refer to FIG. 4C), the second target command for changing the power state of the accelerator 230 may be transmitted from the host device 100 to the NFC 220 of the computational storage system 200. However, an example embodiment of transmitting the second target command according to example embodiments are not limited to the above-described cases.

As described above, according to the computational storage system 200 and an operating method according to the above example embodiments, individual control power of the computing device 210 (e.g., the accelerator 230) may be performed separately from power control of the storage device 250. Accordingly, the computational storage system 200 according to an example embodiment may reduce or prevent undesirable power consumption through adaptive power control according to an operation state of the computing device 210 (e.g., the accelerator 230).

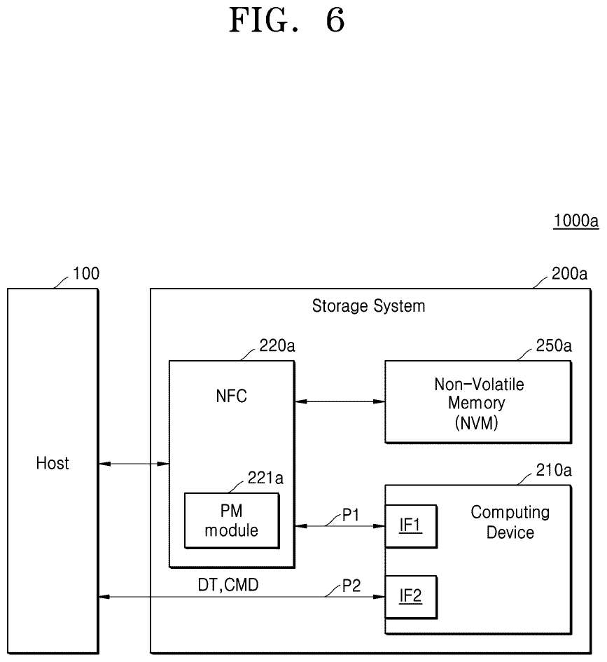

FIG. 6 is a block diagram schematically illustrating a computational storage system and a data processing system according to an example embodiment.

Referring to FIG. 6, a data processing system 1000a may include a host device 100 and a computational storage system 200a, and the computational storage system 200a may include a computing device 210a, an NFC 220a including a PM module 221a, and an NVM 250a. A structure and operation of the computational storage system 200a of FIG. 6 may be similar to the structure and operation of the computational storage system 200 of FIG. 1.

However, as illustrated in FIG. 6, the computing device 210a may directly communicate with the host device 100. The computing device 210a may communicate with the NFC 220a through a first path P1 and communicate with the host device 100 through a second path P2. The computing device 210a may include a first interface IF1 for communication with the NFC 220a and a second interface IF2 for communication with the host device 100.

The computing device 210a may receive data DT or a command CMD, which is not stored in the NVM 250a, through the second path P2. For example, the computing device 210a may receive real-time data (e.g., log data) from the host device 100 through the second path P2 and process the received data DT. In an example embodiment, the computing device 210a may also receive an application through the second path P2. In addition, the computing device 210a may directly transmit a data processing result to the host device 100 through the second path P2 or transmit the data processing result to the NFC 220a through the first path P1, and the NFC 220a may transmit the data processing result to the host device 100.

Moreover, communication and operation between the NFC 220a and the host device 100, and communication and operation between the NFC 220a and the computing device 210a (e.g., an accelerator (not shown) included in the computing device 210a) may be the same as described above with reference to FIGS. 1 to 5. For example, the PM module 221a of the NFC 220a may identify, from among a plurality of commands received from the host device 100, at least one target command related to power control of the computing device 210a (e.g., the accelerator (not shown) included in the computing device 210a). The PM module 221a may individually control power of the computing device 210a according to the at least one target command. For example, the PM module 221a may report current power state information of the computing device 210a (e.g., the accelerator (not shown) included in the computing device 210a) to the host device 100 and may change a power state of the computing device 210a (e.g., the accelerator (not shown) of the computing device 210a) according to the at least one target command received from the host device 100.

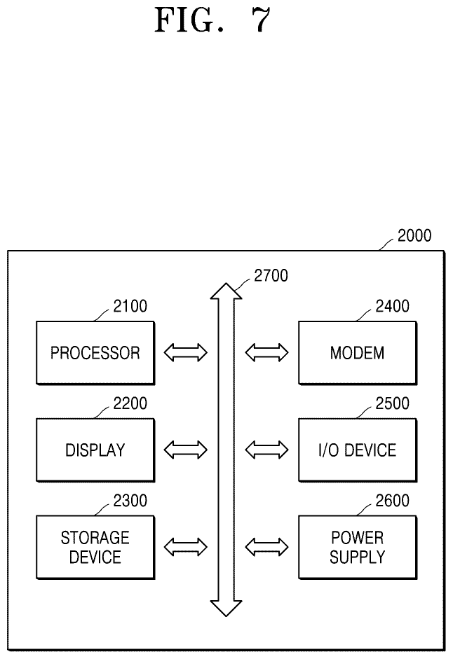

FIG. 7 is a block diagram illustrating an electronic device according to an example embodiment.

Referring to FIG. 7, an electronic device 2000 may include a processor 2100, a display 2200, a storage device 2300, a modem 2400, an input/output (I/O) device 2500, and a power supply 2600.

The electronic device 2000 may be a personal computer (PC), a data server, an ultra mobile PC (UMPC), a workstation, a net-book, a network-attached storage (NAS), a smart television, an Internet of Things (IoT) device, a portable electronic device, or the like. The portable electronic device may be a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game consoles, an e-book, a wearable device, or the like.

The storage device 2300 may include a plurality of storage devices, and each of the plurality of storage devices may be implemented as in the computational storage system 200 described above with reference to FIGS. 1 to 6. Also, the storage device 2300, the processor 2100, the display 2200, the modem 2400, the I/O device 2500, and the power supply 2600 may be connected to one another through a channel 2700.

The storage device 2300 (including the computational storage system 200 of FIGS. 1 to 6) according to the example embodiment as described above may perform power control of the computing device 210 separately from power control of the storage device 250. In addition, the storage device 2300 (including the computational storage system 200 of FIGS. 1 to 6) may adaptively perform the power control of the computing device 210 according to an operation state of the computing device 210. For example, the storage device 2300 (including the computational storage system 200 of FIGS. 1 to 6) may reduce or prevent undesirable power waste by changing a power state of the computing device 210 to an idle state when the computing device 210 does not perform data computing. In addition, the storage device 2300 (including the computational storage system 200 of FIGS. 1 to 6) may improve energy efficiency of the entire system by individually/adaptively performing the power control of the computing device 210.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While the inventive concepts have been particularly shown and described with reference to some example embodiments thereof, it will be understood that various changes in form and details may be made therein without departing from the spirit and scope of the following claims.

What is claimed is:

1. A computational storage system comprising:
a storage device configured to store data; and
a computing device comprising a non-volatile memory express flow controller (NFC), an accelerator, and a memory, the computing device configured to perform data processing on input data provided from a host device outside the storage device or the computational storage system, the NFC including a power management (PM) module,
wherein the PM module is configured to
identify whether or not a target command related to power control of the accelerator is received among a plurality of commands received from the host device, and
perform the power control of the accelerator based on the target command when the target command is received.

2. The computational storage system of claim 1, wherein a type of the target command comprises:
a first target command for requesting power state information supported by the accelerator; and
a second target command for requesting current power state information of the accelerator or changing a power state of the accelerator.

3. The computational storage system of claim 2, wherein the PM module is further configured to
in response to receiving the first target command from the host device,
store, in a first field of the first target command, information regarding a number of power states supported by the accelerator,
store, in subfields of a second field of the first target command, information regarding characteristics of the power states supported by the accelerator, and
transmit, to the host device, the first target command storing the information regarding the number of power states supported by the accelerator and the information regarding the characteristics of the power states supported by the accelerator.

4. The computational storage system of claim 2, wherein the PM module is further configured to identify request content of the host device by decoding a header of the second target command when receiving the second target command.

5. The computational storage system of claim 4, wherein, when the request content of the host device requests the current power state information of the accelerator,
the PM module is further configured to
transmit, to the accelerator, a signal requesting the current power state information of the accelerator based on the second target command,
receive the current power state information of the accelerator from the accelerator, and
store the current power state information of the accelerator in a first field of the second target command and transmit the stored current power state information to the host device.

6. The computational storage system of claim 4, wherein,
when the request content of the host device requests a change in the power state of the accelerator, the PM module is further configured to transmit a control signal for changing the power state of the accelerator to the accelerator based on the second target command, and
information regarding a power state of the accelerator to be changed is stored in a first field of the second target command by the host device.

7. The computational storage system of claim 2, wherein the PM module is further configured to receive the second target command for changing the power state of the accelerator from the host device when an operation state of the computing device is changed.

8. The computational storage system of claim 1, wherein the PM module is further configured to bypass a command related to power control of the storage device to the storage device when receiving the command related to the power control of the storage device from among the plurality of commands received from the host device.

9. A method of operating a computational storage system comprising a computing device and a storage device, the method comprising:
identifying whether or not a target command related to power control of an accelerator of the computing device is received from among a plurality of commands received from a host device outside the computational storage system; and
performing the power control of the accelerator based on the target command when receiving the target command.

10. The method of claim 9, wherein a type of the target command comprises:
a first target command for requesting power state information supported by the accelerator; and
a second target command for requesting current power state information of the accelerator or changing a power state of the accelerator.

11. The method of claim 10, further comprising:
storing, in a first field of the first target command, information regarding a number of power states supported by the accelerator, in response to receiving the first target command from the host device;
storing, in subfields of a second field of the first target command, information regarding characteristics of the power states supported by the accelerator; and
transmitting, to the host device, the first target command storing the information regarding the number of power states supported by the accelerator and the information regarding the characteristics of the power states supported by the accelerator.

12. The method of claim 10, further comprising:
identifying request content of the host device by decoding a header of the second target command when receiving the second target command.

13. The method of claim 12, further comprising:
when the request content of the host device requests the current power state information of the accelerator,
transmitting, to the accelerator, a signal requesting the current power state information of the accelerator based on the second target command,
receiving the current power state information of the accelerator from the accelerator,
storing the current power state information of the accelerator in a first field of the second target command, and
transmitting the stored current power state information to the host device.

14. The method of claim 12, further comprising,
when the request content of the host device requests a change in the power state of the accelerator, transmitting, to the accelerator, a control signal for changing the power state of the accelerator based on the second target command,
wherein information regarding a power state of the accelerator to be changed is stored in a first field of the second target command by the host device.

15. The method of claim 10, further comprising:
receiving, from the host device to the computational storage system, the second target command for changing the power state of the accelerator when an operation state of the computing device is changed.

16. The method of claim 9, further comprising:
bypassing a command related to power control of the storage device to the storage device when receiving the command related to the power control of the storage device from among the plurality of commands received from the host device.

17. An electronic device comprising:
a host device; and
a computational storage system comprising a storage device and a computing device, the computational storage system configured to be operatively connected to the host device,
wherein the computational storage system is configured to
when receiving a first target command or a second target command related to power control of the computing device from the host device, control change of a power state of the computing device based on the first target command and the second target command, and
when receiving a command related to power control of the storage device from the host device, bypass the command related to the power control of the storage device to the storage device.

18. The electronic device of claim 17, wherein the computational storage system is further configured to transmit, to the host device, information regarding an interface supported by the computational storage system and power state information supported by the storage device and the computing device, in response to receiving the first target command from the host device.

19. The electronic device of claim 17, wherein the computational storage system is further configured to transmit current power state information of the computing device to the host device, in response to receiving the second target command from the host device.

20. The electronic device of claim 17, wherein the computational storage system is further configured to change the power state of the computing device based on the second target command, in response to receiving the second target command from the host device.
